(19) United States
(12) Patent Application Publication
(10) Pub. No.: US 2013/0147955 A1
(43) Pub. Date: Jun. 13, 2013

(54) WARNING SYSTEM, VEHICULAR APPARATUS, AND SERVER

(71) Applicant: Takuya Oosugi, Obu-city (JP)

(72) Inventor: Takuya Oosugi, Obu-city (JP)

(73) Assignee: DENSO CORPORATION, Kariya-city (JP)

(21) Appl. No.: 13/613,737

(22) Filed: Sep. 13, 2012

(30) Foreign Application Priority Data
Dec. 12, 2011 (JP) 2011-271406

(51) Int. Cl. H04N 7/18

(52) U.S. Cl. 348/148; 348/E07.085

(57) ABSTRACT

In-vehicle systems are in host vehicles. Each in-vehicle system transmits a vehicle information item indicating a present position, travel course, and size of the host vehicle to a server. Out of the host vehicles, detecting vehicles pass through a dangerous spot where a dangerous object is present. The in-vehicle system in each detecting vehicle transmits a dangerous object information item indicating an image and position of the dangerous spot, to the server. The server extracts warned vehicles expected to pass through the dangerous spot, from the present positions and travel courses of the host vehicles. The server determines a danger degree when passing through the dangerous spot, based on an image of the dangerous spot and a width of each warned vehicle, thereby preparing warning information and distributing it to the in-vehicle system of each warned vehicle.

### CROSS REFERENCE TO RELATED APPLICATION

This application is based on Japanese Patent Application No. 2011-271406 filed on Dec. 12, 2011, the disclosure of which is incorporated herein by reference.

### TECHNICAL FIELD

The present disclosure relates to a warning system, a vehicular apparatus, and a server, which provide warning information to a vehicle which passes through a road where a dangerous object is present.

### BACKGROUND ART

[Patent document 1] JP 2005-4480 A (US 2004/0252192 A)

[Patent document 2] JP 2009-20774 A

In recent years, there is proposed a system in which a server collects traffic information detected by vehicles that travel roads and a drive assist is performed using the traffic information. For example, Patent document 1 describes a system in which in-vehicle cameras capture images of road states in various spots as image information items, and a server collects the image information items from vehicles while providing a specific image information item in a specific spot to a vehicle that is estimated to travel the specific spot.

Further, Patent document 2 proposes a system in which at the time of occurrence of an accident, the accident vehicle reads out photographed image information item from the in-vehicle drive recorder simultaneously while collecting photographed image information items of the accident site from other vehicles that travel in the vicinity. Further, the accident vehicle transmits these photographed image information items to an external server. This configuration makes it easier to investigate the cause of the accident and enables notification of the state of the accident to other vehicles by providing the image information items.

According to the invention described in Patent documents 1, 2, a driver may recognize the road state and accident information in a travel estimated route in advance, and drive the vehicle more smoothly. From a different viewpoint, only image information is provided; thereby, the driver need determine the traffic situation and accident state based on the provided image information. This increases the working load of the driver greatly. Furthermore, the image information is provided uniformly irrespective of the traffic situation or the accident state; therefore, the image information is provided even when the smooth drive is possible. This may increase the working load of the driver more than needs, possibly resulting in not providing the suitable drive assist.

### SUMMARY

It is an object of the present disclosure to provide a warning system that provides a driver with a more suitable drive assist.

To achieve the above object, according to an aspect of the present disclosure, a warning system is provided to include a server and a plurality of vehicular apparatuses in host vehicles, each of which is a vehicle to which each of the vehicular apparatuses is mounted. The vehicular apparatus includes an in-vehicle communicator to wirelessly communicate with the server, a vehicle notification section, a detection section, a distinction section, a whole-image capture section, and a danger notification section. The vehicle notification section is to specify a present position and a travel course of the host vehicle with predetermined intervals, and notify the server of a vehicle information item via the in-vehicle communicator, the vehicle information item specifying a size of the host vehicle and indicating the present position and the travel course of the host vehicle. The detection section is to detect a dangerous object which is present on a road. The distinction section is to distinguish a position of a dangerous spot where the dangerous object is present. The whole-image capture section is to capture a whole image of the dangerous spot. The danger notification section is to notify the server of a dangerous object information item via the in-vehicle communicator, the dangerous object information item indicating the position and the whole image of the dangerous spot. The server includes an in-server communicator to wirelessly communicate with each of the plurality of vehicular apparatuses, an extraction section, a determination section, and a provision section. The extraction section is to extract, out of the host vehicles, a warned vehicle based on the present positions and the travel courses indicated by the vehicle information items acquired from the vehicular apparatuses via the in-server communicator, the warned vehicle being expected to pass through the dangerous spot indicated by the dangerous object information item acquired from the vehicular apparatus. The determination section is to determine a danger degree at a time when the warned vehicle passes through the dangerous spot based on (i) the size specified by the vehicle information item of the warned vehicle, and (ii) the whole image indicated by the dangerous object information item relative to the dangerous object which is present in the dangerous spot through which the warned vehicle passes. The provision section is to provide the vehicular apparatus in the warned vehicle with a warning information item according to the danger degree at the time when the warning vehicle passes through the dangerous spot, via the in-server communicator. The vehicular apparatus further includes a warning section to perform a warning having a content according to the warning information item acquired from the server via the in-vehicle communicator.

Under the above configuration, a driver of the host vehicle equipped with the above vehicular apparatus may be provided with only a warning information item about a dangerous object the driver is expected to encounter with a high probability. In contrast, the driver may not be provided with unnecessary information that includes the information about a spot in which a smooth traffic is still possible, and the information about a dangerous object the driver may encounter with a very low probability.

In addition, the warning information item has a content according to the danger degree at the time when the host vehicle as the warned vehicle passes through the dangerous spot. The driver need not determine a danger degree at the time when passing through the dangerous spot based on the content of the warning information item.

Therefore, according to the above warning system, the driver may receive only necessary warning information; upon receiving it, the driver may be relieved from having the working load to review the received information. This may provide a more suitable drive assist to the driver.

According to another aspect of the present disclosure, a vehicular apparatus is provided as the vehicular apparatus according to the above warning system.

Further, according to yet another aspect of the present disclosure, a server is provided as the server according to the above warning system.

### BRIEF DESCRIPTION OF THE DRAWINGS

The above and other objects, features, and advantages of the present disclosure will become more apparent from the following detailed description made with reference to the accompanying drawings. In the drawings:

FIG. 1A, 1B are block diagrams illustrating overall configurations of a warning system and an in-vehicle system, respectively, according to an embodiment of the present disclosure;

FIG. 2A, 2B, 2C are block diagrams illustrating overall configurations of a navigation apparatus, a drive assist apparatus, and a server, respectively;

FIG. 3 is a diagram for explaining an operation in the warning system between a detecting vehicle and a warned vehicle via a server;

FIG. 4 is a flowchart diagram illustrating a series of processes from when detecting a dangerous object to when distributing warning information;

FIG. 5A is a flowchart diagram illustrating a vehicle information transmission process;

FIG. 5B is a flowchart diagram illustrating a dangerous object detection process;

FIG. 6A is a flowchart diagram illustrating a warned vehicle extraction process;

FIG. 6B is a flowchart diagram illustrating a danger degree determination process;

FIG. 7A is a diagram illustrating contents of warning information;

FIG. 7B is a diagram illustrating conditions to determine a danger degree; and

FIG. 8 is a flowchart diagram illustrating a warning information reception process.

### DETAILED DESCRIPTION

An embodiment of the present disclosure is explained with reference to drawings. In addition, the embodiment of the present disclosure can be modified in various manners within a technical scope of the present disclosure without being limited to the following embodiment.

[Explanation of Configuration]

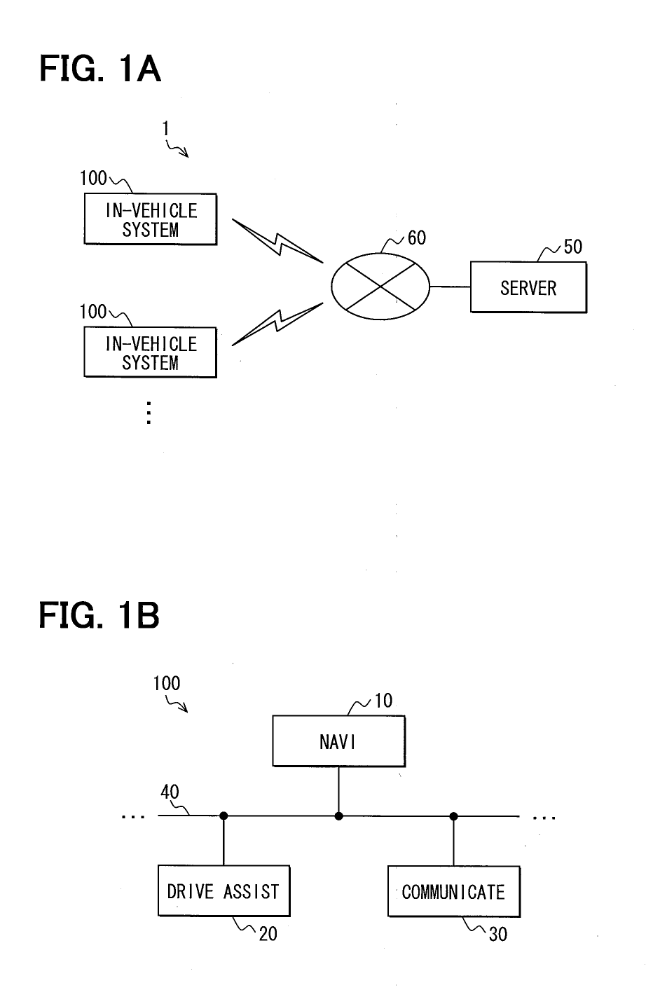

With reference to FIG. 1A, a warning system 1 according to the present embodiment includes a plurality of in-vehicle systems 100 mounted in a plurality of host vehicles, respectively; and a server 50 that can communicates with the in-vehicle system 100 via a wireless communication link network 60. Herein, each of the host vehicles may be defined as a vehicle in which an in-vehicle system 100 is mounted. The in-vehicle system 100 detects a dangerous object on a road and notifies the server 50 of the detected dangerous object. The server 50 notifies the in-vehicle system 100 mounted in a warned vehicle of warning information about the dangerous object. Herein, the warned vehicle may be defined as one of the host vehicles that is estimated to pass through a dangerous spot where the dangerous object is present.

With reference to FIG. 1B, the in-vehicle system 100 includes a navigation apparatus 10 which performs a route guidance etc. using map data, a drive assist apparatus 20 which detects a foreign object on a road ahead of the host vehicle using a camera, and a communication apparatus 30 as a well-known DCM (Data Communication Module) which communicates with the server 50 via the wireless communication link network 60 using an antenna (unshown). The above apparatuses are connected using an in-vehicle LAN (Local Area Network) 40 such as CAN (Controller Area Network).

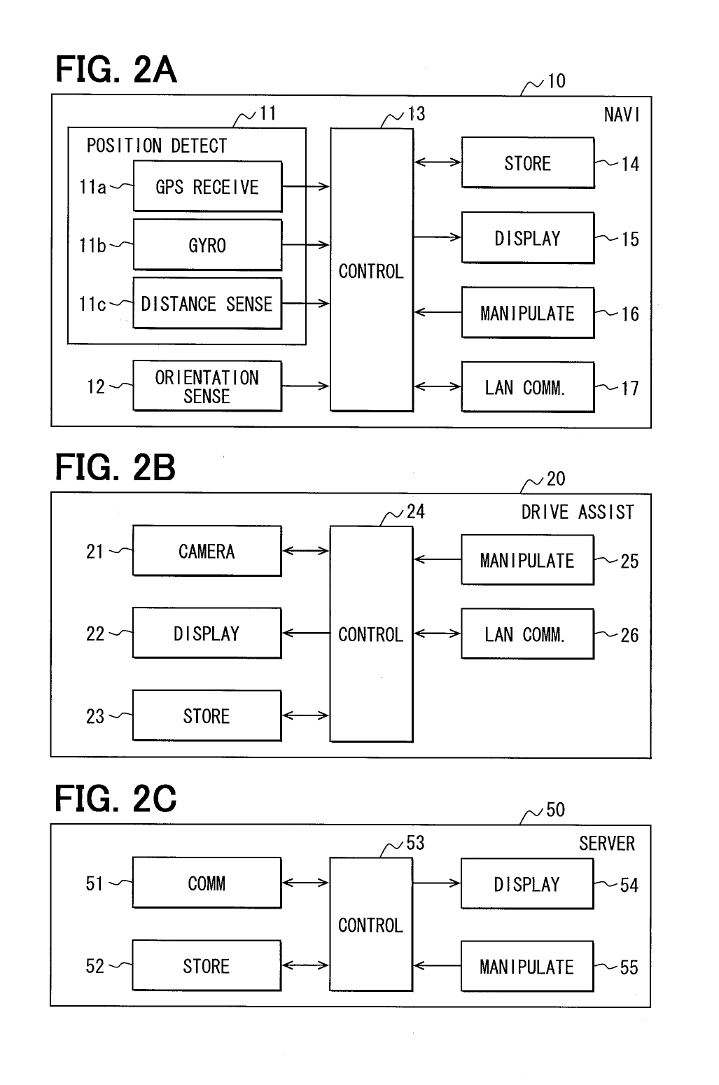

In addition, with reference to FIG. 2A, the navigation apparatus 10 includes the following: a position detector 11 to detect a present position of the host vehicle; an orientation sensor 12 which detects an absolute orientation using geomagnetism; and a control circuit 13 contains a known microcomputer having a CPU, ROM, RAM, I/O, and a bus line connecting the foregoing components or the like to perform an overall control of the navigation apparatus 10 according to a program stored in the ROM or RAM.

The position detector 11 includes the following sensors or the like: a GPS receiver 11a, which receives via a GPS antenna (unshown) signals from satellites for GPS (Global Positioning System) and is used for detecting a position, orientation, and speed of the host vehicle; a gyroscope 11b which detects rotational movement exerted over the host vehicle; and a distance sensor 11c which detects a travel distance of the host vehicle. The individual sensors or the like 11a to 11c have different types of detection errors from each other; therefore, they are used to complement each other.

In addition, the navigation apparatus 10 includes a storage portion 14, a display portion 15, a manipulation portion 16, and an in-vehicle LAN communication portion 17. The storage portion 14 includes a device, which does not need a memory holding operation to retain stored data, such as a HDD (Hard Disk Drive) and a flash memory, and stores a variety of information such as map data. The display portion 15 includes a liquid crystal display and displays a variety of information. The manipulation portion 16 includes a key switch or a touch switch and receives various manipulations. The in-vehicle LAN communication portion 17 communicates with other apparatuses mounted in the host vehicle via the in-vehicle LAN 40.

In addition, with reference to FIG. 2B, the drive assist apparatus 20 includes a camera 21, a display portion 22, a storage portion 23, a control circuit 24, a manipulation portion 25, and an in-vehicle LAN communication portion 26. The camera 21 captures an image covering an area ahead of the host vehicle. The display portion 22 includes an LCD (Liquid Crystal Display) and displays a variety of information. The storage portion 23 includes a nonvolatile memory such as a flash memory. The control circuit 24 contains a known microcomputer having a CPU, ROM, RAM, I/O, and a bus line connecting the foregoing components or the like to operate according to a program stored in the ROM or RAM. The manipulation portion 25 includes a button and receives various manipulations. The in-vehicle LAN communication portion 26 communicates with other apparatuses via the in-vehicle LAN 40.

With reference to FIG. 2C, the server 50 includes a communication portion 51, a storage portion 52, a control circuit 53, a display portion 54, and a manipulation portion 55. The communication portion 51 accesses the wireless communication link network 60. The storage portion 52 includes a device that need not a memory holding operation to retain stored data such as a HDD. The control circuit 53 contains a known microcomputer having a CPU, ROM, RAM, I/O, and a bus line connecting the foregoing components or the like to operate according to a program stored in the RAM or ROM. The display portion 54 includes a liquid crystal display and displays a variety of information. The manipulation portion 55 includes a keyboard or a mouse which receives various manipulations.

[Explanation of Operation]

The following will explain an operation of the warning system 1.

It is further noted that a sequence, flowchart or the processing of the sequence or flowchart in the present application includes sections (also referred to as steps), which are represented, for instance, as S305. Further, each section can be divided into several sub-sections while several sections can be combined into a single section. Furthermore, each of thus configured sections can be referred to as a device, module, processor, or means and achieved not only (i) as a software section in combination with a hardware unit (e.g., computer), but also (ii) as a hardware section, including or not including a function of a related apparatus. Further, the hardware section may be inside of a microcomputer.

(1) Outline

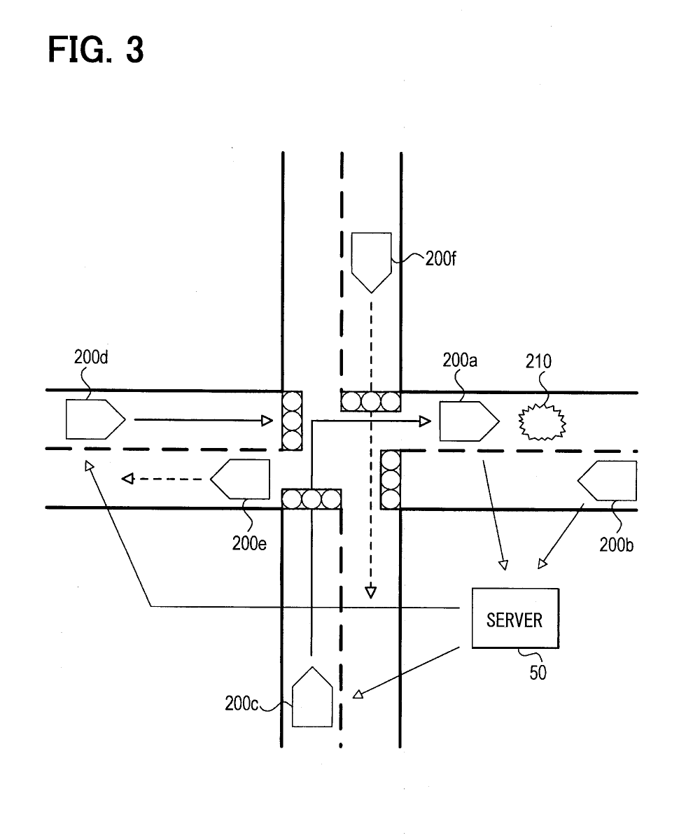

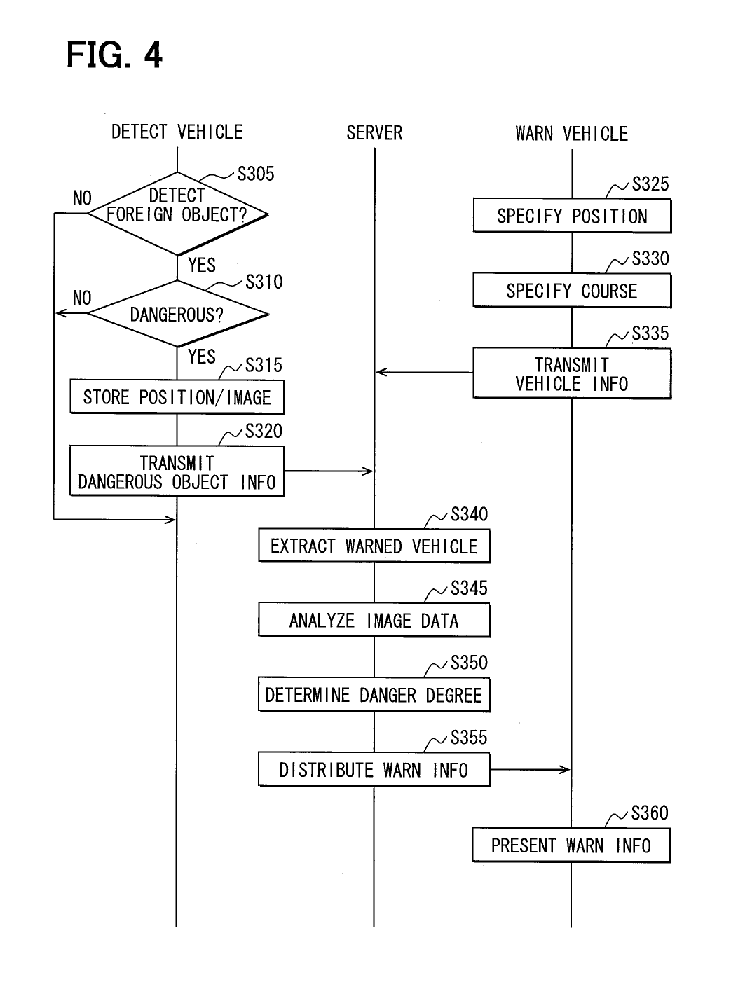

First, an outline of the warning system 1 of the present embodiment will be explained with reference to FIGS. 3, 4. In FIG. 3, the vehicles 200a to 200f indicate the above mentioned host vehicles to which the in-vehicle systems 100 are mounted, respectively.

Each in-vehicle system 100 in the warning system 1 specifies a present position and a travel course of the host vehicle with predetermined intervals (S325, S330), and transmits a vehicle information item that indicates a present position, a travel route, and a size of the host vehicle to the server 50. The server 50 is in a state to constantly recognize a present position and a travel course of each host vehicle by receiving the vehicle information item from each of the in-vehicle system 100.

The travel course of the host vehicle may be a heading direction of the host vehicle or a travel estimated route that is a route, which is estimated to travel according to or along a route guidance by the navigation apparatus 10. In FIG. 3, arrows starting from vehicles 200c to 200f illustrate their travel courses, respectively. The arrow relative to the vehicle 200c indicates a travel estimated route in a route guidance of the vehicle 200c. The arrows relative to the vehicles 200d to 200f indicate heading directions of the vehicles 200d to 200f.

Suppose a case where a dangerous object 210 is present in a road and a dangerous spot of the road is defined as a spot where the dangerous object 210 is present. In such a case, the dangerous object 210 in the dangerous spot is detected by the in-vehicle systems 100 mounted in the host vehicles 200a, 200b, which are also referred to as detecting vehicles.

In detail, the in-vehicle system 100 of each detecting vehicle 200a, 200b detects a foreign object on the road using the camera 21 of the drive assist apparatus 20 (S305: Yes), and determines whether the foreign object is a dangerous object. It is noted that the foreign object may be an obstacle such as a falling object a garbage from a vehicle, a stopping vehicle on an expressway, an accident vehicle, a vehicle which runs backward on a road, or a pedestrian, for instance. In addition, the determination method of determining whether a foreign object is a dangerous object is mentioned later.

When the foreign object is determined to be a dangerous object (S310: Yes), an image of (i) the dangerous object 210 and (ii) a whole of the road where the dangerous object 210 is present is captured by the camera 21 and is stored as an image data item. In addition, when the host vehicle approaches the dangerous object, the position detector 11 of the navigation apparatus 10 specifies a present position and stores the specified present position as a position of the dangerous spot (S315), while transmitting a dangerous object information item which indicates the position of the dangerous spot and includes the image data item about the dangerous object to the server 50 (S320). Herein, for instance, the position may be represented by a set of coordinates (longitude and latitude).

In contrast, upon receiving the dangerous object information item, the server 50 specifies as a warned vehicle a host vehicle that is estimated to pass through a dangerous spot from present positions and travel courses of the host vehicles which are indicated by the vehicle information items received from the in-vehicle systems 100. Thereby, the warned vehicle is extracted which is expected to pass through the dangerous spot, out of the host vehicles equipped with the in-vehicle systems 100 (S340).

In the example of the diagram of FIG. 3, the vehicles 200c, 200d are specified as warned vehicles from the travel courses of the vehicles 200c to 200f. Whether the vehicle 200c arrives at the dangerous spot is determined based on the travel estimated route used as a travel course. In addition, the vehicles 200d to 200f use the heading directions as the travel course. Whether the vehicles 200d to 200f running along roads arrive at the dangerous spot are determined based on the present positions and the heading directions. It is determined that the vehicle 200d arrives at the dangerous spot, out of the vehicles 200d to 200f.

In addition, the server 50 analyzes the image data item contained in dangerous object information item, and specifies vehicle widths of the warned vehicles 200c, 200d based on the sizes indicated by the vehicle information items. The server 50 determines a danger degree at the time when the warned vehicle passes through a dangerous spot based on the analysis results and vehicle widths (S345, S350). Warning information items corresponding to the warned vehicles 200c, 200d are prepared according to the danger degree, and distributed to the corresponding in-vehicle systems 100 (S355).

The vehicle information item may include a model number and type of a specific host vehicle as information indicating a size of the specific host vehicle. In contrast, the size of the vehicle corresponding to each model number or each type may be registered with the server 50. The server 50 may specify a vehicle width of the vehicle corresponding to the vehicle information item based on the model number or the like indicated by the vehicle information item and the registered size of the vehicle.

The in-vehicle system 100 of each warned vehicle 200c, 200d receives the warning information item, and outputs a warning according to the danger degree based on the warning information item via the navigation apparatus 10.

The following will explain a process performed in the warning system 1 in detail.

(2) Vehicle Information Transmission Process

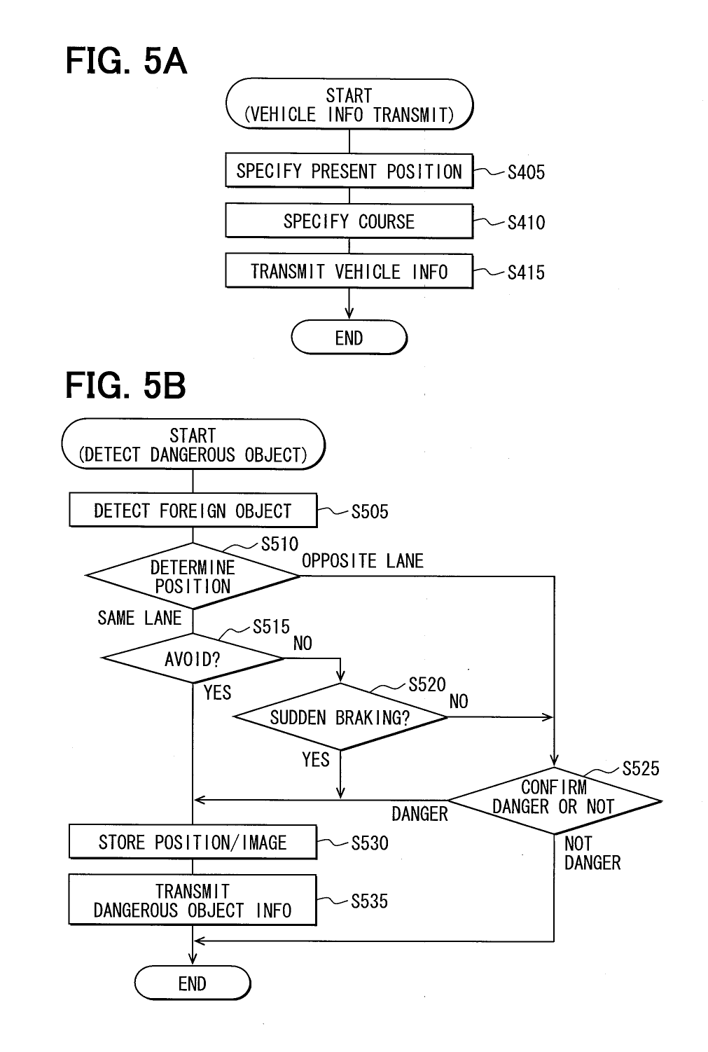

First, with reference to a flowchart in FIG. 5A, a vehicle information transmission process will be explained. In this process, the in-vehicle system 100 notifies the server 50 of a present position etc. of the host vehicle. The present process is performed by the navigation apparatus 10 of the in-vehicle system 100 with predetermined intervals (for example, cycles of five seconds).

At S405, the control circuit 13 of the navigation apparatus 10 specifies a present position of the host vehicle using the position detector 11, thereby advancing the process to S410. At S410, the control circuit 13 specifies a travel course of the host vehicle. For instance, in cases that the navigation apparatus 10 is under a route guidance, the travel course may be a travel estimated route (i.e., a planned travel route or guided route) along which the host vehicle is guided. In cases that no route guidance is made, a heading direction of the host vehicle may be specified based on the history of present positions of the host vehicle and the specified heading direction may be regarded as the travel course. The control circuit 13 then advances the process to S415.

At S415, the control circuit 13 transmits the vehicle information item which indicates the size (width, height, length, etc.) of the host vehicle as well as the present position and travel course of the host vehicle to the server 50 via the communication apparatus 30. The present process is then ended.

(3) Dangerous Object Detection Process

The following will explain a dangerous object detection process with reference to a flowchart of FIG. 5B. In this process, an in-vehicle system 100 detects a dangerous object on a road and notifies the server 50 of a position where the dangerous object is present. It is noted that the present process is performed by the drive assist apparatus 20 and the navigation apparatus 10. The control circuit 24 of the drive assist apparatus 20 detects a foreign object that is present on a road ahead of the host vehicle with predetermined intervals (for example, cycles of five seconds) based on an image of an area ahead of the host vehicle captured by the camera 21; the control circuit 24 then distinguish an on-road position that is a position on a road where the detected foreign object is present. At S505, the control circuit 13 of the navigation apparatus 10 makes an inquiry to the drive assist apparatus 20 whether to have detected a foreign object via the in-vehicle LAN 40. When a response indicating that a foreign object is detected is obtained, the process advances to S510.

At S510, the control circuit 13 of the navigation apparatus 10 makes an inquiry to the drive assist apparatus 20 about the on-road position of the detected foreign object via the in-vehicle LAN 40. When the response from the drive assist apparatus 20 proves that this foreign object is present on a traveling lane the host vehicle is traveling, the process advances to S515. When the response proves that the foreign object is present on a lane different from the traveling lane, the process advances to S525.

At S515, the control circuit 13 determines whether the host vehicle exhibits or conducts a behavior for avoiding this foreign object based on an angular velocity of the host vehicle detected with the gyroscope 11b and an acceleration in a vehicle back and forth direction detected by the distance sensor 11c. Further, the control circuit 13 may specify a locus of the host vehicle based on the history of present positions of the host vehicle detected by the position detector 11, thereby determining whether the above behavior is exhibited, from this locus. When the determination at S515 is affirmed, the process proceeds to S530. When the determination at S515 is negated, the process proceeds to S520.

At S520, the control circuit 13 determines whether sudden braking is made based on the acceleration in the vehicle back and forth direction of the host vehicle detected by the distance sensor 11c and/or the manipulation state of the brake pedal of the host vehicle received from another ECU via the in-vehicle LAN 40. When the determination at S520 is affirmed, the process proceeds to S530. When the determination at S520 is negated, the process proceeds to S525.

At S525, the control circuit 13 makes an inquiry to an occupant of the host vehicle whether the detected foreign object is a dangerous object via the display portion 15 or a speaker (unshown). When a dangerous object detection button included in the manipulation portion 16 is pushed, this foreign object is supposed to be a dangerous object, thereby advancing the process to S530. When the dangerous object detection button is not pushed, this foreign object is supposed to be not a dangerous object, thereby terminating the present process. The above dangerous object detection button is desirably disposed in a position near the driver so as to be easily touched by the driver such as the steering wheel or instrument panel, for instance.

At S530, the control circuit 13 of the navigation apparatus 10 regards the detected foreign object as a dangerous object, and instructs the drive assist apparatus 20 to capture a whole image or perspective of the road where the dangerous object is present via the in-vehicle LAN 40. Upon receiving the instruction, the control circuit 24 of the drive assist apparatus 20 captures the above image once or several times repeatedly to obtain an image data item and store the obtained image data item. The camera 21 is capable of capturing a wide-angled image covering an area ahead of the host vehicle as a whole image of the dangerous spot. The above image data item (i.e., the whole image of the dangerous spot) enables the distinction of the shape and on-road position of the dangerous object, and the magnitude or size of the dangerous object relative to the road width, at least. In addition, a moving image may be captured which can understand a whole image of a road or dangerous spot where the dangerous object is present; then, an image data item may be stored which is used for reproducing the moving image.

In addition, the control circuit 24 of the drive assist apparatus 20 estimates a distance between the host vehicle and the dangerous object based on the image captured with the camera 21. When the estimated distance becomes less than a predetermined value, the control circuit 24 communicates with the navigation apparatus 10 via the in-vehicle LAN 40 to specify a present position of the host vehicle, and stores the specified present position as a position of the dangerous spot where the dangerous object is present, advancing the process to S535.

At S535, the control circuit 24 acquires a vehicle speed of the host vehicle from another ECU and a heading direction of the host vehicle specified based on the history of the present positions from the navigation apparatus 10 via the in-vehicle LAN 40. The control circuit 24 prepares a dangerous object information item, which includes an image data item and indicates a position of a dangerous spot, a vehicle speed and heading direction of the host vehicle, and a detected time of a dangerous object. The control circuit 24 transmits the dangerous object information item to the server 50 via the communication apparatus 30, then ending the present process.

(4) Warning Vehicle Extraction Process

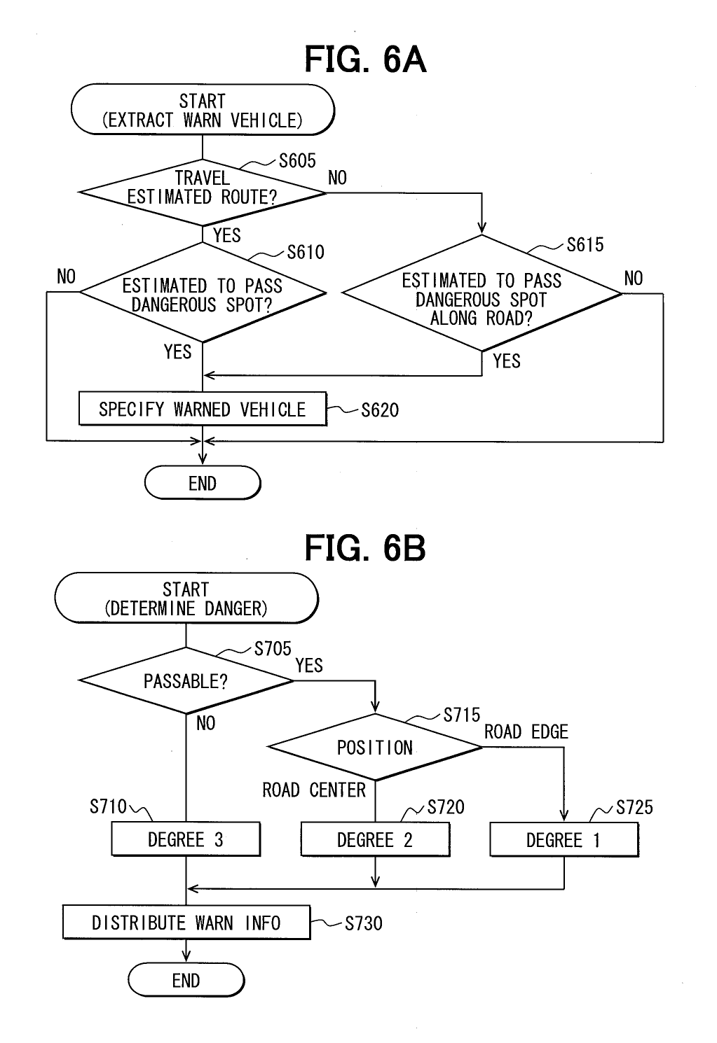

The following will explain a warned vehicle extraction process with reference to a flowchart in FIG. 6A. In this process, upon receiving the dangerous object information item, the server 50 extracts a warned vehicle that is expected to pass through a dangerous spot out of the host vehicles equipped with in-vehicle systems 100. It is noted that the present process is performed by the server 50 for host vehicles which are equipped with the in-vehicle systems 100 other than the in-vehicle system 100 that is a transmission source of the dangerous object information item, after receiving the dangerous object information item.

At S605, the control circuit 53 of the server 50 determines whether the travel course in a newest vehicle information item received from the in-vehicle system 100 of a specific host vehicle is a travel estimated route. When the determination at S605 is affirmed, the process proceeds to S610. When the determination at S605 is negated, the process proceeds to S615.

At S610, the control circuit 53 determines whether the specific host vehicle arrives at the dangerous spot based on the travel course (travel estimated route) of the specific host vehicle. When the determination at S610 is affirmed, the process proceeds to S620. When the determination at S610 is negated, the process is ended.

At S615, the control circuit 53 determines whether the specific host vehicle arrives at the dangerous spot, when the specific host vehicle travels along the road on which the specific host vehicle is running, based on the heading direction of the specific host vehicle. When the determination at S615 is affirmed, the process proceeds to S620. When the determination at S615 is negated, the process is ended.

At S620, the control circuit 53 regards or specifies the specific host vehicle as a warned vehicle, then ending the present process.

(5) Danger Degree Determination Process

The following will explain a danger degree determination process with reference to a flowchart in FIG. 6B. In this process, the server 50 determines a specific danger degree at the time when each warned vehicle passes a dangerous spot, and distributes a warning information item having a content according to the specific danger degree to the in-vehicle system 100 mounted in the warned vehicle.

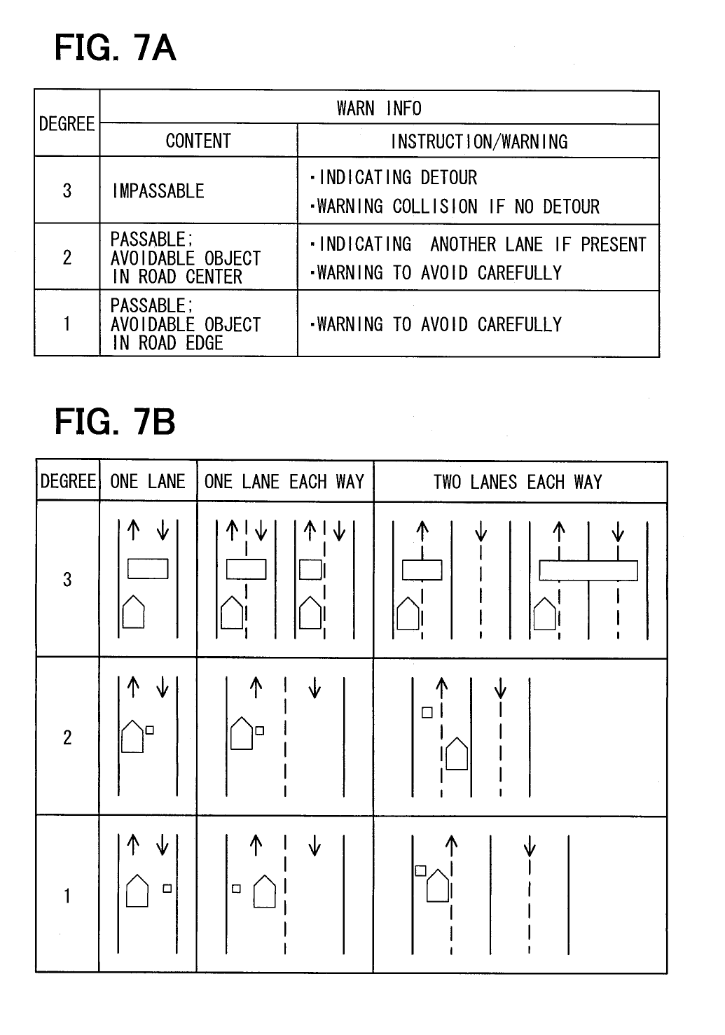

Further, with reference to FIG. 7A, 7B, the danger degree is classified into three levels 1 to 3 according to whether a warned vehicle can pass through a dangerous spot or an on-road position of a dangerous object. As the numerical value of the level becomes great, the accident occurrence probability and the degree of difficulty at the time when a warned vehicle passes through a dangerous spot becomes great.

The danger degree determination process determines a danger degree at the time when a warned vehicle passes through a dangerous spot based on a vehicle width of the warned vehicle and an image data item of the dangerous spot included in the dangerous object information item. It is noted that the present process is performed for each warned vehicle after the warned vehicle is extracted.

At S705, the control circuit 53 of the server 50 specifies a vehicle passable region, which is a region through which a vehicle passes, in the dangerous spot based on the image data item contained in the dangerous object information item received from the in-vehicle system 100 mounted in one or more than one detecting vehicle out of all the host vehicles. The control circuit 53 determines whether a specific warned vehicle can pass through a dangerous spot based on the vehicle passable region and the size (vehicle width) of the warned vehicle indicated by the vehicle information item received from the in-vehicle system 100 mounted in the warned vehicle.

It is noted that the control circuit 53 may analyze the image data item contained in the received dangerous object information item, and generate a three-dimensional image data representing or indicating the road and dangerous object of the dangerous spot. In this case, the three-dimensional image data may be amended based on the vehicle speed and heading direction of the detecting vehicle indicated by the dangerous object information item. Thereby, the vehicle passable region may be specified based on the three-dimensional image data.

In addition, the control circuit 53 may consider the length of the warned vehicle indicated by the vehicle information item in addition to the vehicle width of the warned vehicle so as to determine whether the warned vehicle can pass through. The width of the vehicle passable region may be narrower than the vehicle width of the corresponding warning vehicle; thereby, the warned vehicle may stray onto a road side or an opposite lane if the warned vehicle dare pass through the dangerous spot. In such a case, the control circuit 53 determines that the warned vehicle cannot pass the dangerous spot (S705: NO) and then determines that the danger degree is (level) 3 at S710 (see “Danger degree 3” in FIG. 7B).

In contrast, when the warned vehicle strays close to the road side or changes the lanes to thereby not stray onto the road side or opposite lane, the warned vehicle may pass through the dangerous spot. In such a case, the control circuit 53 determines that the warned vehicle can pass through the dangerous spot (S705: YES).

At S715, the control circuit 53 distinguishes the position where the dangerous object in the dangerous spot is located based on the image data item contained in the dangerous object information item. The dangerous object may be located in a central part of the road of the dangerous spot, or in a central part of any lane having the same heading direction as that of the warned vehicle. In such a case, the control circuit 53 determines that the danger degree is (level) 2 at S720. When the dangerous object is located in an edge of the road or lane, the control circuit 53 determines that the danger degree is (level) 1 at S725. See “Danger degree 2” and “Danger degree 1” in FIG. 7B.

At S730, the control circuit 53 prepares a warning information item, which indicates the position of the dangerous spot and instructs an in-vehicle system 100 to perform a warning according to the danger degree.

In specific, with reference to FIG. 7A, when it is determined that the danger degree is level 3, a warning information item is prepared which indicates that an unavoidable dangerous object is present in the dangerous spot and passing through the dangerous spot is impossible (i.e., the dangerous spot is impassable). In addition, this warning information item further provides an instruction to indicate a detour to bypass the dangerous spot, if present, to the in-vehicle system 100, and provides a warning to avoid a collision to the dangerous object if no detour is present.

Further, when it is determined that the danger degree is level 2, a warning information item is prepared which indicates that an unavoidable dangerous object is present in a central part of the road or a central part of the traffic lane of the dangerous spot but passing through the dangerous spot is possible (i.e., the dangerous spot is passable). In addition, this warning information item further provides an instruction to urge the driver to change the traveling lane to another lane where the dangerous object is not present if the road of the dangerous spot has more than one lane in one traffic way, to the in-vehicle system 100, and provides a warning to avoid the dangerous object carefully if the road has only one lane or the road has a single lane in one traffic way.

When it is determined that the danger degree is level 1, a warning information item is prepared which indicates that an unavoidable dangerous object is present in an edge part of the road or an edge part of the traffic lane of the dangerous spot but passing through the dangerous spot is possible (i.e., the dangerous spot is passable). In addition, this warning information item provides a warning to avoid the dangerous object carefully to the in-vehicle system 100.

The control circuit 53 then distributes the prepared warning information items to the warned vehicles, respectively, via the communication portion 51, then ending the present process.

(6) Warning Information Reception Process

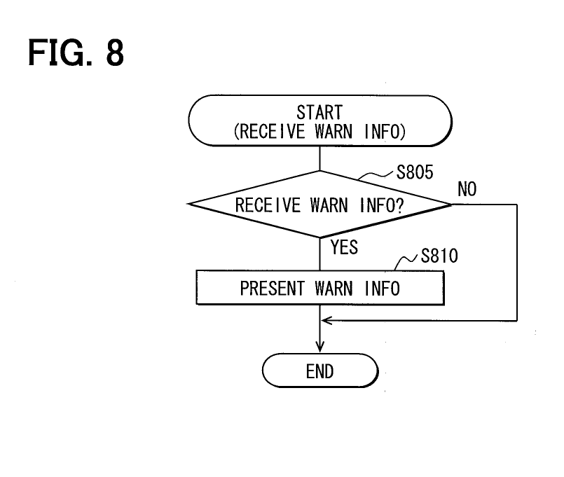

The following will explain a warning information reception process with reference to a flowchart of FIG. 8. This process is performed by the in-vehicle system 100 based on the warning information item. This process is performed by the navigation apparatus 10 with predetermined intervals (for example, cycles of 5seconds).

At S805, the control circuit 13 of the navigation apparatus 10 determines whether to receive a warning information item from the server 50 via the communication apparatus 30. When the determination at S805 is affirmed, the process proceeds to S810. When the determination at S805 is negated, the process is ended.

At S810, the control circuit 13 superimposes the position of the dangerous spot on a map image displayed in the display portion 15, and performs a warning having a content according to the received warning information item via the display portion 15 or speaker (unshown) to the driver. The present process is then ended.

### Effect of Embodiment

According to the warning system 1 of the present embodiment, a dangerous object on a road is detected by an in-vehicle system 100 mounted in each host vehicle; a dangerous object information item about the dangerous object is transmitted to the server 50. Upon receiving the dangerous object information item, the server 50 extracts warned vehicles, which are expected to pass through the dangerous spot where the dangerous object is present, out of the host vehicles equipped with the in-vehicle systems 100. The server 50 further determines a danger degree at the time of passing through the dangerous spot with respect to each warned vehicle, and notifies each warned vehicle of a warning information item having a content according to the determined danger degree.

Thus, a driver of the warned vehicle equipped with the above in-vehicle apparatus 100 may be provided with only a warning information item about a dangerous object the driver is expected to encounter with a high probability. The driver may be not provided with unnecessary information such as information about the spot in which a smooth traffic is possible and information about a dangerous object which the host vehicle is expected to encounter with a low probability.

In addition, the warning information item has a content according to the danger degree at the time when the warned vehicle passes through the dangerous spot. The driver need not determine a danger degree at the time when passing through the dangerous spot based on the content of the warning information item.

Therefore, according to the warning system 1 of the present embodiment, the driver may receive only the necessary warning information; the driver who received the warning information may be relieved from having a working load to analyze it. This may provide a more suitable drive assist to the driver.

Further, according to the warning system 1 of the present embodiment, more than one detecting vehicle of the host vehicles may detect a single specific dangerous object. In such a case, the server 50 can collect more than one dangerous object information item about the specific dangerous object. In addition, the in-vehicle system 100 can also detect a dangerous object which is present in another lane different from a traveling lane the host vehicle is running or which is present in an opposite lane.

Therefore, the server 50 can obtain the image data items which are obtained by capturing the dangerous spot from various angles or viewpoints with respect to the specific dangerous object. Such image data items enable specifying of a passable region in the dangerous spot with a higher accuracy, or preparing a three-dimensional image data relative to the dangerous spot. This achieves a determination of a danger degree of each warned vehicle expected to pass through the dangerous spot with more sufficient accuracy, and provides the warned vehicles with the warning information items having more suitable contents, respectively.

### Other Embodiments

(1) In the above embodiment, the in-vehicle system 100 is configured to include the navigation apparatus 10, the drive assist apparatus 20, and the communication apparatus 30. Without need to be limited to the above, another configuration may be adopted. For example, the in-vehicle system 100 may be replaced with a single ECU which has the function equivalent to the in-vehicle system 100.

In addition, the communication apparatus 30 serving as a DCM performs wireless communication between the in-vehicle apparatus 100 and the server 50. Without need to be limited thereto, the wireless communication between the in-vehicle system 100 and the server 50 may be performed using a wireless LAN, WiFi (registered trademark), light beacon, cellular phone, etc.

(2) Further, in the warning system 1 of the present embodiment, the detection of the dangerous object and the determination of the danger degree at the time when the warned vehicle passes through the dangerous spot are performed based on the image data photographed by the camera 21 of the drive assist apparatus 20. There is no need to be limited thereto. For example, a whole image or perspective of the road where the foreign object is present may be detected by a radar. The detection of the dangerous object and the determination of the danger degree may be performed using the detection result by the radar.

(3) Further, in the present embodiment, the server 50 extracts all the vehicles that are expected to pass through the dangerous spot as warned vehicles. For example, out of the host vehicles expected to pass through the dangerous spot, only host vehicles, which have sizes (i.e., width, length) greater than that of a detecting vehicle, may be extracted as warned vehicles.

In addition, the in-vehicle system 100 may specify a driving tendency of the host vehicle, and transmit the vehicle information item which indicates this driving tendency to the server 50. For example, out of the host vehicles expected to pass through the dangerous spot, the server 50 may extract as a warned vehicle a host vehicle having a high occurrence frequency in sudden braking or sudden turning of the steering wheel and a high difficulty in a safe driving.

This helps prevent the warning from taking place more than needed in the host vehicle that passes through the dangerous spot.

(4) In addition, the in-vehicle system 100 mounted in the warned vehicle may detect the behavior of the warned vehicle (i.e., host vehicle) at the time of passing through the dangerous spot, and notify the server 50 of the passage information which indicates the size of the host vehicle, and the detected behavior. The server 50 may determine the danger degree of the warned vehicle which is estimated to pass through the dangerous spot based on the size and the passage information of the warned vehicle having passed through the dangerous spot. The danger degree of the each warned vehicle can be determined with more sufficient accuracy.

(5) In addition, the drive assist apparatus 20 may be removed from the in-vehicle system 100 of the present embodiment. In such a case, the vehicle information transmission process and warning information reception process may be performed, but the dangerous object detection process may not be performed. Even in such a case, the in-vehicle system 100 can acquire from the server 50 the similar warning information item based on the dangerous object information item about the dangerous object detected by another vehicle, and can perform drive assist in a similar manner in lower costs.

The in-vehicle system 100 may be referred to as a vehicular apparatus. The communication apparatus 30 may be referred to as an in-vehicle communicator. The communication portion 51 of the server 50 may be referred to as an in-server communicator. In addition, the vehicle information transmission process may be referred to as a vehicle notification section, device, or means.

In addition, S505 to S525 of the dangerous object detection process may be referred to as a detection section, device, or means. Further, S530 of the dangerous object detection process may be referred to as a distinction section, device, or means, or a whole-image capture section, device, or means. Further, S535 of the dangerous object detection process may be referred to as a danger notification section, device, or means. Further, a warned vehicle extraction process may be referred to as an extraction section, device, or means.

In addition, S705 and S715 of the danger degree determination process may be referred to as a determination section, device, or means. In addition, S730 of the danger degree determination process may be referred to as a provision section, device, or means. In addition, S810 of the warning information reception process may be referred to as a warning section, device, or means.

In addition, a manipulation of manipulating the dangerous object detection button of the manipulation portion 16 of the navigation apparatus 10 may be referred to as a predetermined manipulation.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A warning system including (i) a server and (ii) a plurality of vehicular apparatuses in host vehicles, the host vehicle being a vehicle to which each of the vehicular apparatuses is mounted,
the vehicular apparatus comprising:
an in-vehicle communicator to wirelessly communicate with the server;
a vehicle notification section to
specify a present position and a travel course of the host vehicle with predetermined intervals, and
notify the server of a vehicle information item via the in-vehicle communicator, the vehicle information item specifying a size of the host vehicle and indicating the present position and the travel course of the host vehicle;
a detection section to detect a dangerous object which is present on a road;
a distinction section to distinguish a position of a dangerous spot where the dangerous object is present;
a whole-image capture section to capture a whole-image of the dangerous spot; and
a danger notification section to notify the server of a dangerous object information item via the in-vehicle communicator, the dangerous object information item indicating the position and the whole image of the dangerous spot,
the server comprising:
an in-server communicator to wirelessly communicate with each of the plurality of vehicular apparatuses;
an extraction section to extract, out of the host vehicles, a warned vehicle based on the present positions and the travel courses indicated by the vehicle information items acquired from the vehicular apparatuses via the in-server communicator, the warned vehicle being expected to pass through the dangerous spot indicated by the dangerous object information item acquired from the vehicular apparatus;
a determination section to determine a danger degree at a time when the warned vehicle passes through the dangerous spot based on (i) the size specified by the vehicle information item of the warned vehicle, and (ii) the whole image indicated by the dangerous object information item relative to the dangerous object which is present in the dangerous spot through which the warned vehicle passes; and
a provision section to provide the vehicular apparatus in the warned vehicle with a warning information item according to the danger degree at the time when the warning vehicle passes through the dangerous spot, via the in-server communicator,
the vehicular apparatus further comprising:
a warning section to perform a warning having a content according to the warning information item acquired from the server via the in-vehicle communicator.

2. The warning system according to claim 1, wherein:
the detection section detects (i) a foreign object which is present ahead of the host vehicle, and (ii) a behavior of the host vehicle at the time when the host vehicle passes through the dangerous spot where the foreign object is present; and
the detection section detects the foreign object as the dangerous object based on the behavior that is detected.

3. The warning system according to claim 1, wherein:
the detection section detects a foreign object which is present ahead of the host vehicle, and the detection section receives a predetermined manipulation from an occupant in the host vehicle; and
the detection section detects as the dangerous object the foreign object when receiving the predetermined manipulation when detecting the foreign object.

4. The warning system according to claim 1, wherein:
the vehicular apparatus includes a navigation function; and
the vehicle notification section specifies as the travel course a travel estimated route that is a route that the host vehicle is estimated to travel in a route guidance by the navigation function.

5. A vehicular apparatus in a host vehicle, the host vehicle being a vehicle to which the vehicular apparatus is mounted, the vehicular apparatus having an in-vehicle communicator that wirelessly communicates with a server,
the server acquiring vehicle information items about a plurality of the host vehicles, the vehicle information item specifying a size, a present position, and a travel course of each of the host vehicles,
the server acquiring a dangerous object information item which indicates a position of a dangerous spot where a dangerous object is present and a whole image of the dangerous spot,
the vehicular apparatus comprising:
a vehicle notification section to specify a present position and a travel course of the host vehicle with predetermined intervals, and notify the server of a vehicle information item relative to the host vehicle via the in-vehicle communicator, the vehicle information item specifying a size of the host vehicle and indicating the present position and the travel course of the host vehicle; and
a warning section to perform a warning having a content according to a warning information item acquired from the server via the in-vehicle communicator,
the warning information item being according to a danger degree at a time when the host vehicle passes through the dangerous spot,
the danger degree being determined by the server based on (i) the size specified by the vehicle information item relative to the host vehicle, and (ii) the whole image indicated by the dangerous object information item in cases that the server defines the host vehicle as a warned vehicle, which is expected to pass through the dangerous spot indicated by the acquired dangerous object information item, based on the vehicle information item relative to the host vehicle.

6. The vehicular apparatus according to claim 5, further comprising:
a detection section to detect a dangerous object which is present on a road;
a distinction section to distinguish a position of the dangerous spot where the dangerous object is present;
a whole-image capture section to capture a whole image of the dangerous spot; and
a danger notification section to notify the server of the dangerous object information item, which indicates the position and the whole image of the dangerous spot, via the in-vehicle communicator.

7. A server including an in-server communicator that communicates with each of a plurality of vehicular apparatuses in host vehicles, the host vehicle being a vehicle to which the vehicular apparatus is mounted,
the server acquiring from the vehicle apparatus a dangerous object information item, which indicates (i) a position of a dangerous spot on a road, the dangerous spot where a dangerous object is present and (ii) a whole image of the dangerous spot,
the server acquiring, from the vehicular apparatuses vehicle, information items, which indicate sizes, present positions, and travel courses of the host vehicles,
the server comprising:
an extraction section to extract, out of the host vehicles, a warned vehicle based on the present positions and the travel courses indicated by the vehicle information items acquired from the vehicular apparatuses via the in-server communicator, the warned vehicle being expected to pass through the dangerous spot indicated by the dangerous object information item acquired from the vehicular apparatus;
a determination section to determine a danger degree at a time when the warned vehicle passes through the dangerous spot based on (i) the size specified by the vehicle information item of the warned vehicle, and (ii) the whole image indicated by the dangerous object information item relative to the dangerous object which is present in the dangerous spot through which the warned vehicle passes; and
a provision section to provide a warning information item to the vehicular apparatus in the warned vehicle via the in-server communicator,
the warning information item having a content according to the danger degree at the time when the warning vehicle passes through the dangerous spot.
